(19) United States
(12) Patent Application Publication
(10) Pub. No.: US 2013/0232517 A1
(43) Pub. Date: Sep. 5, 2013

(54) AUDIENCE MEASUREMENT APPARATUS, SYSTEM AND PROCESS

(71) Applicant: IBOPE PESQUISA DE MÍDIA E PARTOCOPAÇÕES LTDA., Sao Paulo SP (BR)

(72) Inventor: Alex Reis dos Santos, Sao Paulo SP (BR)

(73) Assignee: Ibope Pesquisa de Mídia e partocopações Ltda., Sao Paulo SP (BR)

(21) Appl. No.: 13/782,227

(22) Filed: Mar. 1, 2013

(30) Foreign Application Priority Data
Mar. 1, 2012 (BR) BR102012004645-8

(51) Int. Cl. H04N 21/442

(52) U.S. Cl. CPC H04N 21/44213
USPC 725/14

(57) ABSTRACT

The present invention relates to an audience measurement apparatus (100) associable to a TV set (200) provided with a screen (4) that displays at least one piece of OSD (on screen display) information referring to the tuned channel, characterized by comprising at least one camera (1) configured to record at least one image (8) of at least a part of the areas of the screen (4) of the TV set (200), where the piece of OSD information is displayed and means to process the image (8) and detect the tuned channel.

Besides the audience measurement apparatus (100), this specification also disclosed a process and system for audience measurement.

The present invention relates to a system of measuring television audience, this system being enabled to measure the audience of a television set through a camera that projects towards the television set and manages to capture audience information displayed on the screen.

### Description of the Prior Art

There is a great commercial interest in measuring television audience in general. This interest takes place chiefly by reason of the need to quantify and determine which target public watches a given content on television at a given moment.

This information may be useful for advertizing agents, producers, a TV-broadcaster that a is a competitor of the one that broadcasts said programs, among other interested parties that make use of these data for taking important decisions in their respective areas of activity.

In order to start measuring the audience of a given television set, a mechanism is necessary which detects a change in the channel that is being watched (that is, a change in the tuning state). When the new channel is tuned to, a piece of audience information is generated. In this way, with every change of channel a new piece of information should be generated, in order to follow what a given TV-view has watched.

Some known methods for detecting a change in channel are: (i) angular position of the selector of old TV sets, (ii) the frequency of the local oscillator, (iii) the tuning voltage, (iv) tuning of analog television sets, (v) monitoring of the channel display via LED display or Electroluminescent Valve, (vi) monitoring of the channel display on the image-tube screen, (vii) the monitoring of cable-TV tuner, and (viii) monitoring of the channel display on the television-set screen. The information on the tuning channel is then recorded by an audience-measuring piece of equipment.

There is still a specific technique for recognizing the channel by the TV set, by searching for characteristics existing in the video stream supplied to the TV set by cable-channel tuning set-to-box apparatus, either via satellite or via ground broadcasting, which is known as “channel grabber”.

With this technique, the frames that compose the image of a television program are captured by means of a video capturing card with signals received in formats PAL-M, PAL-N, NTSC or SECAM, which delivers the digitalized images in the form of RGB with 8 (eight) bits of quantization with 25 or 30 pfs (twenty-five or thirty frames per second). Only the “net” data of each frame are received. Therefore, synchronism and VBI signals are not received.

The recognizing system is based on the verification of similarity between images contained in a databank and pre-processed images. The whole search for patterns works with images in gray tone or binary images, depending on the script recorded. Information relating to color is used in some filters for binarization of the processed images. There are various functions to make use of boxes (image areas) that analyze parts of the image captured, whereby the performance is improved and each application is generated depending the need for it, since each set-top-box has a different functionality, with information arranged at different places of the image, the most varied colors possible and the characters displayed following the same sources (“source” should be understood as a type of letter).

One further provides a system for filtering the images in gray tones, made prior to analysis of similarity, for eliminating the intensity variation existing in dark backgrounds. The same filtering is made in the databank before it is recorded.

The search for character is exhaustive (character to character, pixel to pixel), with the correlation criterion for images in gray tones and verification of pixel-to-pixel equality with binary images.

The use of the channel grabber technique with capture of images by electric signal causes the application to have a more controlled environment, free from abrupt variations in illumination, which constitutes an advantageous aspect. Moreover, the creation of configurable functions and parameters, while keeping the functioning of the sensor based on a script, imparts versatility to the sensor, since it is not necessary to generate software versions for each new set-top-box created by the industry.

On the one hand, a considerable disadvantage of this technique lies in the fact that, at installations where the digital television synchronizers are incorporated into the television set, without the use of any type of set-top-box apparatus, it may not be used. This difficulty will become greater with the increase in mass incursion of television sets with digital technology of high-definition open channel tuning.

The above-mentioned methods are sued depending on the condition of the television sets to be monitored. Anyway, once in possession of the information on the tuned channel, the audience measuring equipment can register and send this information to the interested parties in real time, or store these data and transmit them only after a programmed time.

As far as the television sets are concerned, as a general rule, the models available on the market at present are divided into: interactive television sets (which are still a minority) and non-interactive television sets (the vast majority of the sets). The interactive-set audience is generally measured through a technology called “remote-measurement system”, whereas in the measurement of non-interactive sets (that is, conventional TV sets) one uses method described before, depending on the TV-set model and the installation.

As an example of an apparatus for audience measurement, one can cite the apparatus described in document US2008/0155583, called UNITAM system. This set has a number of input port for connections with a TV set and with the apparatus connected to it. Through these connections the apparatus collects information transmitted to the TV set and generates audio subscriptions for each source of information recorded.

An advantage of the set-top-box apparatus is that they can be associated to conventional TV sets, devoid of interactive or digital communication means, for instance. However, said set-top-boxes interfere directly with the communication means of the TV set, and so they may raise the installation costs of the apparatus or impair the communication systems connected to the television set.

There is a more modern methodology, which configures a remote measurement system, characterized in that it does not make use of an apparatus connected directly to a specific TV set for assessing audience. An example of this type of technique is disclosed in document US 2002/0087969, the assignee of which is IBM.

This document discloses a program for measuring audience of interactive TV sets through a hyperlinks system, introduced in the middle of the programs by the broadcasting network itself. The system has various functions, such as monitoring specific themes and texts access to by the user. The hyperlinks can be linked to a number of different themes such as objects, scenes and actors, and may assume different forms, according to the interest of the broadcasting network.

The hyperlinks system of this prior art has the advantage of not interfering directly with the communication means of the TV set. In other words, said system does not need to be plugged to the internal devices of the

TV set or to its communication means (such as an antenna cable or subscription TV set) in order to perform its function of measuring audience. This characteristic imparts considerable value to this technology, since it does not require installation services or raise the costs of the measurement with the production of an individual apparatus for each TV set monitored.

As an advantage of the remote measurement system, it is incapable of associating to TV sets devoid of interactive communication systems, such as conventional analog TV sets.

Until now, the prior art does not embrace any apparatus of system that does not interfere directly with the communication means of TV sets, is not invasive and is capable of recording TV audience by making use of only the images transmitted by the TV-set screen.

In the same way, one can conclude that the prior art does not embrace an audience measuring apparatus or system capable of measuring the audience of any type of TV set, regardless of the technology used by the TV set, by capturing images displayed on the TV-set screen. Objectives of the invention

The present invention has the objective of providing an apparatus and a system for measuring audience of at least one TV set, which does not interfere directly with the communication means of the TV set, carrying out the measurement by capturing images that come directly from the TV-set screen.

Further, the present invention has the objective of providing a process of measuring audience of at least one TV set by capturing images that come directly from the TV-set screen.

### BRIEF DESCRIPTION OF THE INVENTION

The objectives of the present invention are achieved by an audience measurement apparatus associable to a TV set provided with a screen that displays at least one piece of OSD information (OSD=on screen display, an image imposed by the TV set with the task of informing the user) referring to the tuned channel, wherein the apparatus comprises at least one camera configured to record at least one image of at least a part of area of the TV-set screen where the OSD (on screen display) information is displayed and means for processing the image and detecting the tuned channel.

Also, the objectives of the present invention are achieved by means of an audience measurement system that comprises at least one audience measurement apparatus as defined in the previous paragraph, associated to at least one TV set, the apparatus having commutation capacity, at least one software and at least one connection to any means for transmission of the audience information.

Finally the objectives of the present invention are achieved by means of an audience measurement process that uses at least one audience measuring apparatus provided with at least one camera as defined in the two preceding paragraphs, comprising the following steps:

Step (i): the apparatus is actuated when a TV view turns on the TV set or changes the channel;

Step (ii): the camera captures an image displayed on at least a part of the TV-set screen;

Step (iii): the apparatus times a specific period to determine whether the channel related to the image is effectively being watched by the TV view or if it corresponds only to an intermediate channel; and

Step (iv): the apparatus processes the image identifying which channel it belongs to;

### BRIEF DESCRIPTION OF THE DRAWINGS

The present invention will now be described in greater detail with reference to an example of embodiment represented in the drawings. The figures show:

FIG. 1 is a is a first schematic perspective view of the audience measuring apparatus of the invention;

FIG. 2 is a second schematic perspective view of the audience measuring apparatus of the present invention;

FIG. 3 is a front view of the audience measuring apparatus of the present invention, positioned on the TV set, forming the audience measuring system of the present invention;

FIG. 4 is a perspective view of the audience measuring apparatus in operation, positioned on the TV set, forming the audience measurement system of the present invention;

FIG. 5 is a view of the audience measuring apparatus of the present invention, showing an external projection comprising, on its lower face, a camera for capturing audience images;

FIG. 6 is a side view of the external projection of the audience measuring apparatus of the present invention in a first possible embodiment;

FIG. 7 is a side view of the external projection of the measurement apparatus of the present invention in a first possible configuration;

FIG. 8 is a view of the audience measurement system of the present invention at the moment when the measurement apparatus captures an audience image on the TV-set screen;

FIG. 9 is a view of the image captured by the camera of the measurement apparatus of the present invention, after computeraided correction for correcting perspective distortion.

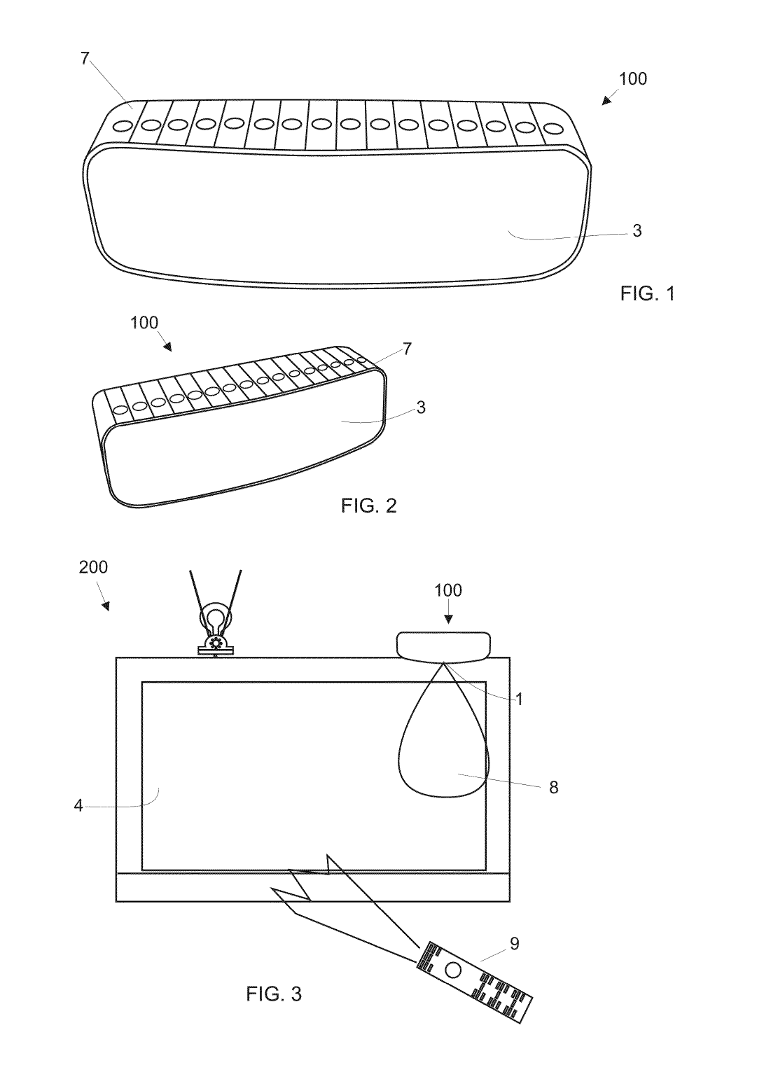

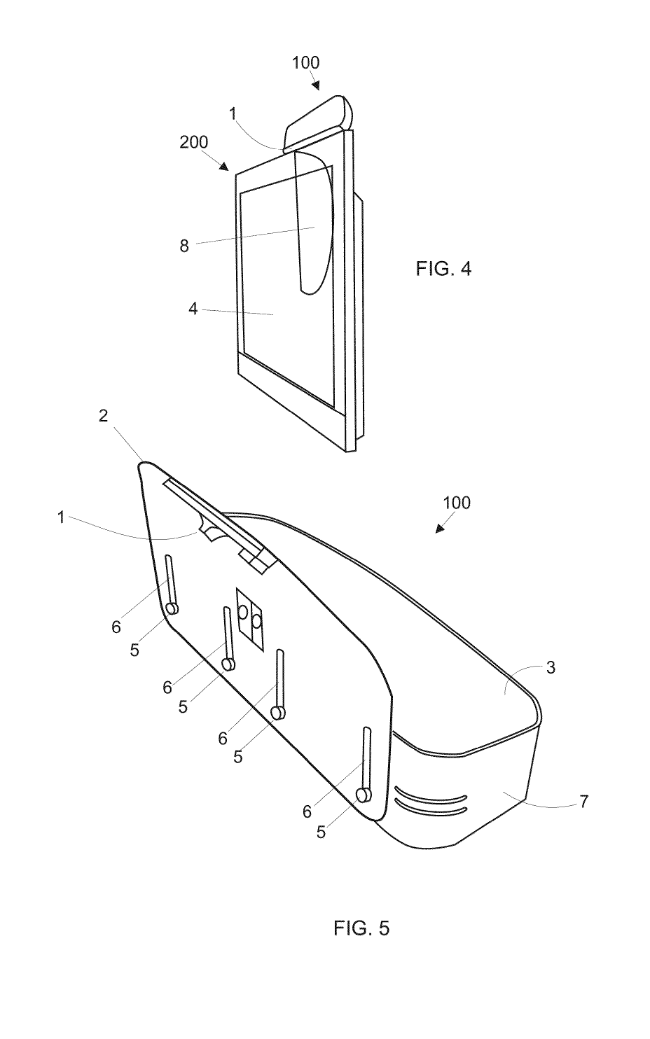

### DETAILED DESCRIPTION OF THE FIGURES

The present invention relates to an audience measurement apparatus 100, more particularly to an apparatus 100 for measuring TV-set 200 audience. This apparatus, together with other components that will be described later, forms a novel and innovatory audience measuring system, which in turn operates an audience measuring method. The apparatus, system and process for measuring audience are included in the protection scope of the accompanying claims.

The audience measurement apparatus 100 of the present invention is the element responsible for the innovations of the present invention, since it has an innovative constitution.

Conceptually speaking, the audience measurement apparatus 100 is constituted as a set-to-box, that is, an electronic apparatus provided with a protective box 7, shaped to be positioned adjacent any television set 200, which enables one to measure audience. Preferably, but not compulsorily, the apparatus 100 is positioned on the top surface of the television set 200.

However, unlike most conventional audience recorders, the audience measuring apparatus 100 of the present invention is a non-invasive system of detecting audience, which makes use of a small camera 1 to capture images 8 displayed on the screen 4 of a television set 200 and, on the basis thereof, indicate the channel or programs being watched.

The present invention applies to any television set, regardless of the mark, model or size, which uses the screen as a means for showing the number of the channel tuned and the volume utilized, among other pieces of information called OSD (on screen display).

Although this is a general rule, the manner in which the information on the tuned channel is displayed on the screen (position, size, type and color of letter, etc., doesn't follow any pre-established rule.

Besides displaying information about the channel number, some pieces of equipment also inform the name of the broadcaster tuned, current time, gives information on the program being broadcast, broadcaster grid, etc. This is possible when these pieces of information are received by the antenna signal, depending on the analog or digital system that being tuned (PAL-N, NTSC, ISDB-T, etc.).

The main function of the camera 1 is to collect images 8 displayed on the screen 4 of the screen of the TV set 200, to determine, by means of the images captured, the channel (s) being watched by a determined television viewer, without using invasive detection systems or methods on the television set 200 and without intercepting the electric signals corresponding to the programs before they reach the television set 200 (for example cable TV-signals).

The rule by which every television set makes this information available also applies to the fact that the television set does not make this information available via video output port independently, if it is an analog (AV) or digital (HDMI/DVI) output port.

Thus, since it detects the tuning signal from images displayed on the TV-set screen, the audience measurement apparatus 100 of the present invention simulates the human eye, viewing the information supplied on the screen instead of capturing it via video signal output.

It is important to mention that, just as the human brains needs the eyes to capture images, in the present invention the camera 1 is responsible for capture of color images, control of image focus and compatibility with the most varied image patterns.

For the human brain needs a minimum sampling frequency of 25 fps (twenty-five frames/second), since with this frequency the human eye manages to compose the various photographs being captured and assembly a video. When a video camera is used for capturing images and supplying them to a computer, one should follow the same rule if the intention is to make a video available, without jitters for the human brain.

The audience measurement system of the present invention is not so strict as the human brain, since in reality what is desirable are the recordings of change of scope, audience, in order to trace completely all that was made available to the TV view by the television set.

It is important to mention further that there are a few complicating factors when a camera is to be installed in a domicile with respect to numberless physical varieties of the environment: dimensions, pieces of furniture, physical arrangement of the furniture, screens between the camera and the TV set, etc.

The solution for overcoming the mechanical problems relating to the installation of a camera in a so varying environment is to change the view point of the camera by using the TV set 200 itself as a base, that is, with the apparatus that is the target of sensing itself serving to annul the mechanical difficulties.

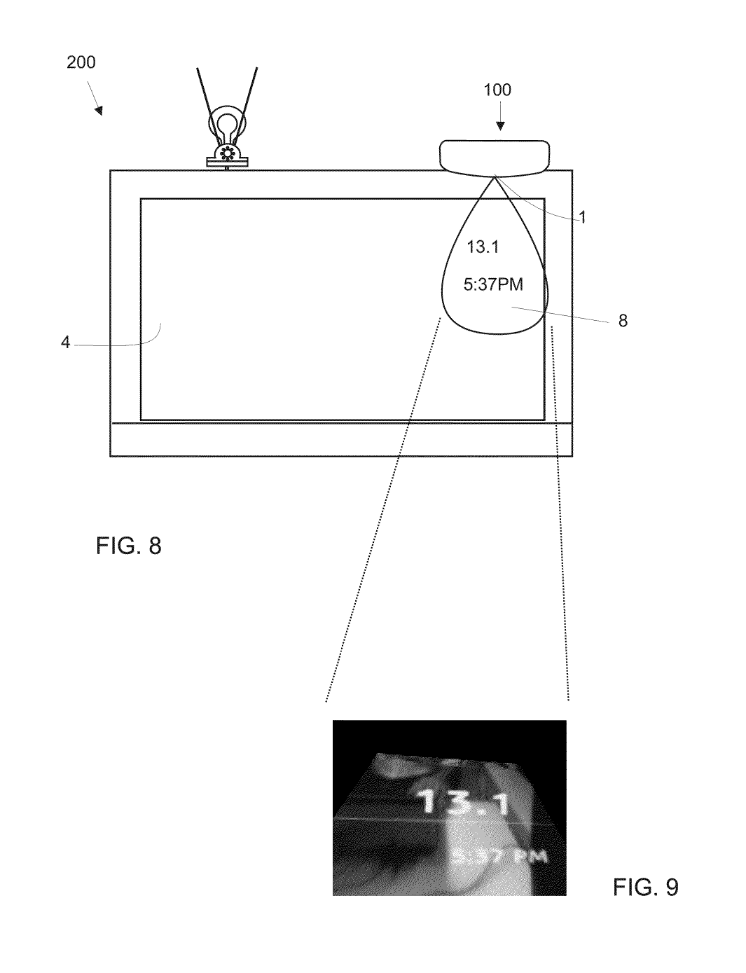

Specially FIG. 8 illustrates the apparatus 100 provided with a camera 1 installed on a conventional LCD TV set. The same figure shows the amount of information which the ISDB-T (Integrated Services Digital Broadcasting Terrestrial) makes available to the users, such as: tuned channel number, time, next programs, contents being shown at the present moment, etc.

In a first embodiment of the apparatus 100, the camera 1 has the capacity of capturing a portion of the screen, and for this purpose the installation has to be customized from TV set to TV set, since each television set makes use of its own OSD (on screen display) at an upper corner of the screen. However, it is possible to use a camera with a larger field of vision, which manages to capture images from the whole TV screen.

The camera 1 of the apparatus 100 is arranged on the bottom face of an external projection 2 under a given degree of inclination capable of enabling one to capture images 8 from the screen 4 of the TV set 200.

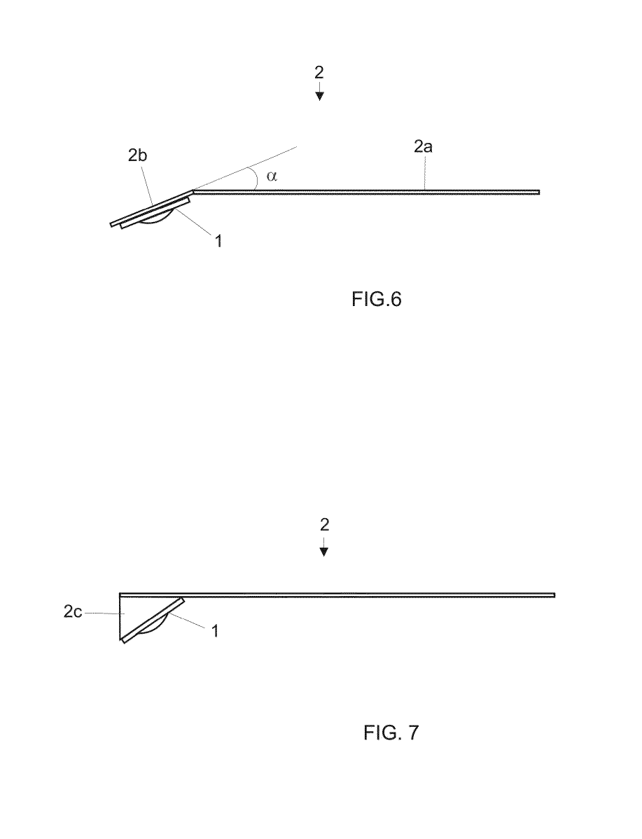

This inclination can be provided by the physical shape itself of the external projection 2, as can be seen in FIG. 6 of this specification. In this figure it is possible to see that the external projection 2 comprises first portion 2a and second portion 2b, the first portion 2a being associated to the apparatus 100 and the second portion 2b being suspended outside the apparatus 100 and inclined with respect to the first portion 2a (see angle α in FIG. 6).

Preferably, the camera 1 should be positioned in such a way, that the image capture angle (angle between the TV screen plane and the axis orthogonal to the focal plane of the camera) will range from 30 and 60 degrees. This position generates a final image that is a product of the contents displayed by the TV set 200 (called real image). In this way, the image captured by the camera 1 is a perspective view of the image displayed on the screen of the TV set 200, but it enables the interpretation of the contents of the OSD (on screen display) that will be identified later.

It is important to note that the camera 1 can capture reflexes that alter the color patterns of the real image (see FIG. 9, which illustrates an OSD (on screen display) image after it was captured by the camera 1 and corrected by computer process), which happens depending on the type of television set and programs transmitted.

Evidently, the geometric architecture of the equipment 100 may vary freely, without the resulting invention failing to be included in the protection scope of the accompanying claims.

Thus, in a possible embodiment, the external projection 2 may have means that enable displacement thereof with respect to the apparatus 100, such as, for example, screws 5 capable of displacing along oblong bores 6 defined in the first portion 2a of the external projection 2 (see FIGS. 5 and 6).

In another alternative configuration, said inclination of the external projection 2 may be provided by a third element 2c, the triangular section geometry of which enables one to house the camera 1 at an inclination capable of admitting the capture of images 8 from the screen of the TV set 200 (see FIG. 7).

Further, the camera 1 may be arranged on the front face of the apparatus 100, which is configured to be positioned with its upper part projecting toward the screen 4 of the TV set 200.

It is further possible to configure the apparatus 100 so that the camera 1 will be located in a front or side position, so that the apparatus 100 will be in front of or at the side of the TV set 200, or still any other required or desirable configuration.

In the preferred embodiment of the present invention, the camera 1 works with images of the right upper quadrant of the TV set 200, as illustrated in FIG. 9. From that image, the apparatus should identify the channel being watched.

When the TV view watches TV, most of the time the captured images do not contain any channel number, since it is included only on two occasions: (i) either when there is a change in channel or (ii) at the request of the user to the TV set via remote control, for instance, in order to verify that the channel is being watched (in the second situation, however, there is no change in audience).

The apparatus 100 has computer means (for example, a microprocessor supported by a software) to “extract” from the image obtained by the camera 1 the information on the channel being tuned. In other words, it is provided with computer capability and at least one software capable of interpreting the images 8 obtained by the camera 1 and sending the data resulting from the interpretation of these 4 images 8 to a data collecting central.

Preferably, the function routine of the apparatus is programmable, which gives the freedom to achieve better performance in the various existing models of TV set. In both cases, there are various pieces of information on the screen that can guide the camera 1 by indicating that a valid OSD (on screen display) is on the screen. For this purpose, it is possible to define image analysis areas, each of which can carry out the task.

For instance, the apparatus 100 may be programmed to read the channel number that is above this reference every time the expression “next program” appears.

After the images have been captured by the camera 1, they undergo filtering processes, so that one can segment the characters of the other elements belonging to the background (background of the image with the contents of the broadcasting station, or a black screen that is usually presented when there is a change of broadcasting station). There are various relevant pieces of information regarding the shape, color, brightness, texture, etc., that are used in the filtering and segmenting process, after which the user can choose from two different processes of identifying the characters: template matching (verification of similarity through analysis between a data-bank existing on the apparatus) or OCR (optical character recognition—a process of identifying character that takes into consideration various factors, such as: shape, image moment, etc.; a process resistant to rotation, scale and brightness).

Each TV set manufacturer has a rule of its own for inserting the OSD (on screen display) messages, sometimes varying from model to model and from size to size. In this way, the apparatus 1 has been constructed so that its installation can be handled properly.

Some models of TV sets have OSD (on screen display) at the upper right corner, while others have it at the upper left corner and, in the same way, the height at which the OSD (on screen display) will appear also varies. Moreover, there are consistent variations in size of the characters, brightness, shape or color.

Due to these factors, one should make some adjustments for positioning the apparatus 100 with respect to the TV set 200, namely (i) adjustment of the support of base support of the camera 1 (external projection 2) to the TV set and (ii) adjustment of the camera inclination.

The first adjustment, which associates the external projection 2 to the TV set 200, has the objective of regulating the camera 1 with respect to the horizontal position, as a function of the quadrant of the TV set on which the OSD (on screen display) is displayed.

The second adjustment, in turn, aims at regulating the capture angle of the camera 1, in order to adjust the vertical reach position on the screen to capture the OSD (on screen display).

Thus, the position of the camera is adjusted on the coordinates x and y (horizontal position and vertical position, respectively).

In the preferred embodiment illustrated in the figures, the camera 1 captures images of a small portion of the screen of the TV set 200, where the OSD (on screen display) information is arranged. In this way, the computer means necessary for identifying the channels being tuned by the TV set are minimized, since the resulting images have a low byte capacity and, as a result, the apparatus 100 has contained manufacture cost and consumption of electric current.

Further about the preferred embodiment of the invention, each image captured has the size of 160×120 pixels in the RGB color system with a resolution of 8 (eight) bits per pixel. This frame may still be subdivided into various boxes, analysis areas, further increases the computational performance.

The calibration of the camera 1 is important so that the images can be captured correctly, specifically in order to prevent inaccuracy due to perspective distortion created by the capture angle, which varies depending on the size of the TV set and the location of the OSD (on screen display) on the screen. Thus, there is a calibration procedure, which is carried out, preferably but not compulsorily, by using a template and a computer, so that its functioning can be verified remotely over the Internet.

The preferred calibration process consists in positioning a template at the same point on the TV screen where the channel number appears. This template is a rectangle with black lines and 5-pixel thickness. After the template has been fixed, the installer activates the apparatus 100 so that the camera 1 will capture an image from this template and makes the necessary configurations.

Right afterward, the image captured by the camera 1 is processed on the computer and the one who is responsible for the calibration (an installing processional) should then confirm or not whether the captured image is a trapeze with its borders marked in red. This marking indicates that the template contours have been recognized correctly.

The fact that the figure is a trapeze and not the same rectangle that was fixed on the TV screen shows the perspective effect described before. With the trapeze marked in red, the installer will determine that the equipment should effect computationally the correction of perspective (transforming the trapeze into a rectangle, just like the template) and the camera 1 should capture an image again. In this way, this new image will undergo a computational processing and will appear without the deformation caused by the perspective effect.

On the on hand, when the camera 1 captures images from the whole screen of the TV set 200, it is necessary for the apparatus 100 to have greater computational power.

This solution can be more interesting especially when the TV set 200 used is small and/or when one wishes to monitor other information described by the TV set, for instance, upon change of a tuned channel for the contents of another electronic device present in the domicile.

However, the determination of the exact place where the apparatus 100 should be positioned is more complex, since the camera 1 should be farther from the TV set 200, so as to capture images from the whole screen. Preferably, this is achieved by using an adequately sized auxiliary base and, depending on the size of the TV set 200, one can make use of two cameras 1, the images of which are then integrated thanks to the computational processing (which generates a single image).

In this type of installation there are various pieces of information that are relevant to the audience measurement, like the OSD (on screen display) itself, logotype of the broadcasting station (by using the detection method of the Brazilian patent document PI 0704122-5), the name of the broadcasting station (when the system is ISDB-T), banners or infoboxes, TiVo, etc.

With the camera 1 positioned away for capturing the whole screen, the perspective effect is smaller, since it is positioned so as to have an almost total vision of the TV set. In this way, the images obtained by the camera 1 have the initial main function of identifying the TV set and making a segmentation of the screen, separating what is part of the borders of the TV set 200 and other objects belonging to the domicile background.

All the possible functions for the installation are programmable by the installer, so that complex or simple installations coexist in the same version of the apparatus 100.

Thus, one selects how many boxes (areas of the screen of the TV set) should be analyzed and which functions in each box should be analyzed, thus making it possible to extract visual information of time-shift viewing in some boxes, besides the current audience in another, or only use the OSD as an audience identifier in a single box.

The audience measurement apparatus 100 of the present invention has various methods of identifying audience, using the audio emitted by the electronic pieces of equipment, measuring the tuning frequency, measuring the tuning voltages, analyzing video signals, etc. Since the present method is not evasive, it does not need subscription validation centrals, nor does it need transmission of data to generate audience.

In other words, the apparatus 100 itself effects the analysis of the images and detects which channel is being watched. From this point on, the it is enough for it to send this information to its recipient (the company that operates it and carries out the audience measurements of a given sample of TV viewers, for instance).

Additionally, when the apparatus 100 makes the analysis of the whole screen of the TV set, it is capable of discovering whether the contents to be shown comes from the tuning of the TV set itself or from another source: DVD, videogame, etc. This is due to the fact that the TV sets have to interact with the user so that the change of tuning source can be made. At this moment, words like AV1, AV2, HDMI, USB, etc., appear at some point on the screed. In this way, it becomes possible to discover, for instance, that the TV viewer has stopped watching TV and has begun to see DVD movies.

The great originality in the apparatus 100 and in the audience measurement method of the present invention lies in that fact that they obtain images and generate audience from the analysis/processing thereof. In this way, there is no need for a video input port on the apparatus 100, so that the images can be captured. It also proves to be original by integrating more than one camera 1 for the generation of images when the apparatus 100 is configured to obtain images from the whole screen of the TV set.

The audience measuring system commented before comprise, in addition to the audience measurement apparatus, the TV set 200 on which it is installed, the existing software and at least one connection to any means for transmission of the audience information (fixed telephone line, cellular, dedicated network, among others). Evidently, the system may comprise a plurality of apparatus 100, each being associated to a TV set 200.

In this regard, it should be noted that the data sent by the apparatus 100 can be sent in real time (instantaneously at the moment of capture and processing of image 8), or may be carried out at determined intervals of time. In order for the second option to be possible, it is necessary for the apparatus 100 to comprise a memory device capable of storing this information during the intervals between the communications with the data collection central.

The audience measurement process that uses the apparatus 100 is a novel and inventive invention and comprises the following steps:

Step (i); the interpretation process of the apparatus 100 identifies when the TV viewer turns on the TV set 200 or changes channel (detection of channel change);

Step (ii): the camera 1 captures an image 8 displayed on at least a part of the screen 4 of the TV set 200;

Step (iii): the apparatus 100 times a specific period of time (preferably fifteen seconds) to determine whether the channel related to the image is effectively being watched by the TV viewer or if it corresponds only to an intermediate channel, accessed rapidly and inadvertently between a change of channels far from each other.

If, after a determined lapse of time, the apparatus 100 concludes that the TV viewer continues watching the same channel, the process goes on to the next step (step (iv)), otherwise the process starts again in step (i).

Step (iv): the apparatus 100 processes the image 8 to identify to which channel it belongs;

Step (v): the apparatus 100 records the result of the processing of image 8, that is, the information on the tuned channel and the date (year, month, day, time, minute and second) of the observation.

However, as can be seen hereinafter, small modifications may be made in the concept disclosed above, without these modifications altering the core of this invention.

As to the advantages achieved by the technology described in this specification, one can cite: (i) the low cost of this measurement system; (ii) the adaptability of this system to the most varied models of TV set 200; (iii) the non-invasive characteristic of this technology; and (vi) the precision in measuring audience.

The low cost of this technology results from the following factors:

this technology enables one to manufacture only one model of apparatus 100, which is capable of adapting to any type of TV set 200;

this technology eliminates the costs with installations existing in other set-top-boxes, which need to be plugged to the electronic means of the TV set 200, so that the information necessary to detect audience can be obtained.

Said adaptability, in turn, is related to the fact that the apparatus 100 comprises a camera 1, capable of obtaining images 8 from any model of TV set 200, unlike the models of measurers or the prior art.

The non-invasive characteristic of this technology further represents one more advantage for this product, since besides being linked to the adaptability and the installation cost of the final product, this characteristic does not impair or jeopardize the electronic apparatus to which the set-top-boxes were connected formerly, that is, the TV set 200 itself and the cables and antennas associated to it.

It should be reiterated that, a preferred example of embodiment having been described, it should be understood that the scope of the present invention embraces other possible variations, being limited only by the contents of the accompanying claims, which include the possible equivalents.

1. An audience measurement apparatus (100) associable to a TV set (200) provided with a screen (4) that displays at least one piece of OSD (on screen display) information referring to the tuned channel, characterized by comprising at least one camera (1) configured to record at least one image (8) of at least a part of the screen (4) area of the TV set (200), where the OSD (on screen display) information is displayed and means for processing the image (8) and detecting the tuned channel.

2. An apparatus (100) according to claim 1, characterized by being provided with computational capacity and at least one software capable of interpreting the images (8) obtained by the camera (1) and sending the data resulting from the interpretation of these images (8) to a data collecting central.

3. An apparatus (100) according to claim 1, characterized by comprising an external projection (2) consisting of first portion (2a) arranged on the bottom surface of the apparatus (100) and second portion (2b) suspended in the environment outside the TV set (200), the external projection (2) being configured to provide visual access of a camera (1) installed under its bottom face to at least a part of the area comprised by the screen (4) of the TV set (200).

4. An apparatus (100) according to claim 3, charaterized in that the second portion (2b) of the external projection (2) defines an inclination at an acute angle (α) with respect to the plane comprised by the first portion (2a) of the external projection (2), this inclination projecting toward the screen (4).

5. An apparatus (100) according to claim 3, characterized in that the first portion (2a) of the external projection (2) is associated to the apparatus (10) by means of screws (5) capable of displacing through oblong bores (6) with respect to the external projection (2), the sets of screws (5) and oblong bores (6) being capable of providing mobility between the external projection (2) and the apparatus (100).

6. An apparatus (100) according to claim 3, characterized in that the camera (1) is arranges on the front face of the apparatus (100), the apparatus (100) being configured to be positioned in front of the screen (4) of the TV set (200), with its front facing the screen (4).

7. An apparatus (100) according to claim 1, characterized by comprising two cameras (1) that capture images, the images of the two cameras (1) being integrated thank to the computational processing, generating a single image.

8. An audience measurement system, characterized by comprising an audience measurement apparatus (100) as defined in claim 1, associated to at least one TV set (200), the apparatus (100) having computational capacity, at least one software and at least one connection to any means for transmission of the audience information.

9. An audience measurement process that uses at least one audience measurement apparatus (100) provided with at least one camera (1) as defined in claim 1, characterized by comprising the following steps:
Step (i): the computational process of the apparatus (100) detects when a TV viewer turns on the TV set (200) or changes channel;
Step (ii): the camera (1) captures an image (8) displayed on at least a part of the screen (4) of the TV set (200);
Step (iii): the apparatus (100) times a specific period of time to determine whether the channel related to the image is effectively being watched by the TV viewer or if it only corresponds to an intermediate channel; and
Step (iv): the apparatus (100) processes the image (8) identifying to which channel it belongs.

10. A process according to claim 9, characterized by further comprising a step (v) in which the apparatus (100) sends information on the tuned channel to the recipient.
